(19) United States
(12) Patent Application Publication
(10) Pub. No.: US 2007/0046109 A1
(43) Pub. Date: Mar. 1, 2007

(54) Miniature linear motor driving device and auto-focus lens device using the same

(75) Inventors: Wen Jen Ho, Shalu Township (TW); Chi Lone Chang, Jhudong Township (TW)

Correspondence Address: TROXELL LAW OFFICE PLLC, SUITE 1404, 5205 LEESBURG PIKE, FALLS CHURCH, VA, 22041, US

(73) Assignee: PowerGate Optical Inc.

(21) Appl. No.: 11/266,295

(22) Filed: Nov. 4, 2005

(30) Foreign Application Priority Data
Aug. 25, 2005 (TW) 094129059

(51) Int. Cl. H02K 41/00; G02B 15/14

(52) U.S. Cl. 310/12; 359/694

(57) ABSTRACT

A miniature linear motor driving device for lens focusing is disclosed. Said driving device comprises a holder, at least a driving coil, and at least a magnetic guide rail. The holder is disposed with at least a guide hole and can be used to accommodate the lens unit. The driving coil is wound around the periphery of guide hole. The magnetic guide rail is secured through the guide hole and formed with a first polarity and a second polarity opposing each other at each end. The holder engages in linear displacement along the magnetic guide rail. A predetermined magnetic force is generated by supplying current to said driving coil, which interacts with the polarities at both ends of magnetic guide rail to push the holder to move linearly along the magnetic guide rail.

### BACKGROUND OF INVENTION

1. Field of the Invention

The present invention relates to a miniature linear motor driving device for use in auto-focus lens unit, more particularly a driving device suitable for application in lens unit that uses linear motor as power source for focusing and supplies power by means of the electromagnetic action between a driving coil and magnetic guide rail disposed therethrough.

2. Description of the Prior Art

As shown in FIG. 1, a standard camera 1 comprises a lens set 11, a sensor 12 and a focusing mechanism (not shown in the figure). The lens set 11 forms an image on sensor 12 by refracting the light rays from an object. If the distance between lens set 11 and sensor 12 is fixed (i.e. a fixed lens), the lens can only show clearly objects at its hyperfocal distance (e.g. 2-3 meters away). For the camera to shoot objects clearly at varying distances (for example at a close distance), the distance between lens set and sensor must be adjusted using a focusing mechanism.

The mechanical focusing mechanism 2 used in conventional camera (as shown in FIG. 2) typically consists of an expensive precision drive element 21 (e.g. stepping motor, ultrasonic motor, and piezoelectric actuator) to supply the power needed to drive the lens holder 22 that carries the lens set 11 and a considerable number of driving elements. Such design has the deficiencies of complicated mechanical configuration, time-consuming assembly, bulkiness and high cost. Most seriously, it consumes a large amount of power. As technology advances, camera makers have been gearing their efforts towards developing high picture quality and small-sized products for easy carriage. Other electronic device makers also focus on integrating more functions in one device by, for example, combining the functions of photographing and mobile communication of handset, the functions of photographing and personal digital assistant (PDA), or the functions of photographing and notebook computer to give the device more powerful video functions. Based on the design of a common power supply having the same capacity as that for a device with single function, how to reduce the size and the cost of product, how to lower power consumption to effectively improve the standby time and run time of the integrated product become the focus of research for electronic product manufacturers.

U.S. Pat. No. 5,150,260 discloses a mechanism that uses stepping motor as actuator to drive the lens unit. Such design offers the advantage of open-loop control, but the whole mechanism takes considerable space, which renders the miniaturization of modules difficult. Also the longer response time of stepping motor leads to greater vibration and noise during operation, which is the biggest drawback for this kind of actuator.

U.S. Pat. No. 6,392,827 discloses a design that uses piezoelectric actuator to drive the lens unit. Piezoelectric actuator offers the merits of fast response, high resolution, and ease of miniaturization. But the “high voltage” operation, the brittleness of piezoelectric material, and ease of wear pose considerable problem for photographic devices when considering piezoelectric actuator for driving the lens.

U.S. Pat. Nos. 5,220,461 and 5,471,100 disclose a linear motor actuator that is superior to stepping motor in overall utilization of space and offers better response time. But it consumes more power and employs close-loop control, therefore having room for improvement.

### SUMMARY OF INVENTION

The primary object of the present invention is to provide a miniature linear motor driving device and auto-focus lens using the same, which offers the advantages of smaller size, simpler structure and less power consumption as compared to prior art.

Another object of the present invention is to provide a miniature linear motor driving device, characterized in which a driving coil is wound around the periphery of a magnetic guide rail in a non-contact manner and a holder is linked to either the magnetic guide rail or the driving coil. Based on the principle of electromagnetic induction, when current is applied to the driving coil, the magnetic action between the magnetic guide rail and the driving coil causes displacement motion between them, thereby driving the movement of holder, and the magnetic guide rail also provides guidance for the direction of displacement. As such, the driving device does not need to have an additional guide rail arranged, thereby further reducing the number of elements used, reducing the size and simplifying the configuration of device. In addition, as the magnetic flux lines of driving coil converge directly on the magnetic guide rail, better driving efficiency is achieved and more power is saved.

Yet another object of the present invention is to provide a miniature linear motor driving device, which, by using a magnetic sensor to detect the position of holder as position feedback during holder displacement, offers the advantages of smaller size, lower cost, and precision positioning.

A further object of the present invention is to provide a miniature linear motor driving device which is configured with a unique prepressed spring that when the holder is at the initial position, the prepressed spring engages the holder to secure it in place, when the holder starts to move, the prepressed spring bends and deforms to apply a predetermined pressure on the holder to further stabilize it in the course of moving.

### BRIEF DESCRIPTION OF THE DRAWINGS

For further understanding the objects, the characteristics, and the functions of the structures of the present invention, a detailed description matched with corresponding drawings are presented as follows.

FIG. 1 is a diagram showing the focusing principle of conventional lens.

FIG. 2 is an exploded view of conventional auto-focus lens.

FIG. 3 is an external view of a preferred embodiment of an auto-focus lens device in assembly with a miniature linear motor driving device according to the invention.

FIG. 4 is an exploded view of the auto-focus lens device shown in FIG. 3 under the first viewing angle.

FIG. 5 is an exploded view of the auto-focus lens device shown in FIG. 3 under the second viewing angle.

FIG. 6 is an exploded view of the auto-focus lens device shown in FIG. 4 under the third viewing angle.

FIG. 7 is an external view of the auto-focus lens device in FIG. 3 in assembly state after the removal of upper cover.

FIG. 8 is a diagram showing the magnetic action between magnetic guide rail and driving coil in the miniature linear motor driving device according to the invention.

FIG. 9A is the A-A sectional view of the auto-focus lens device in FIG. 3 showing the holder at a posterior position.

FIG. 9B is the A-A sectional view of the auto-focus lens device in FIG. 3 showing the holder driven to an anterior position.

FIG. 10 is another preferred embodiment of magnetic guide rail in the miniature linear motor driving device according to the invention.

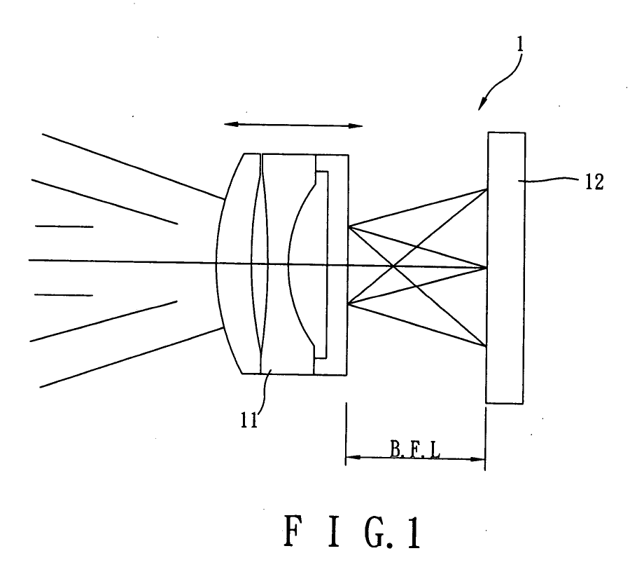

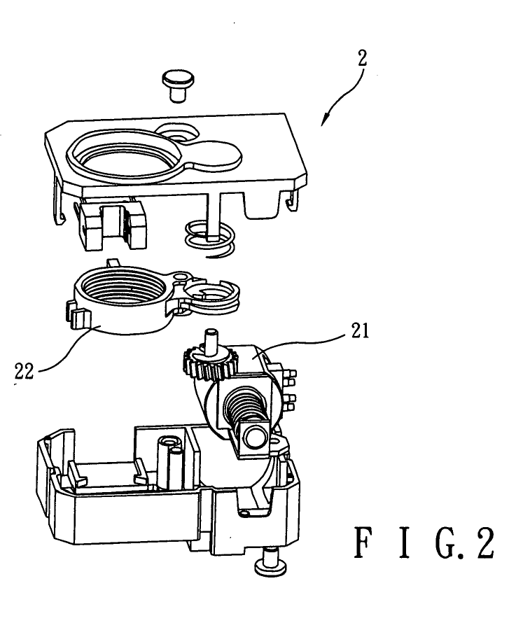

### DETAILED DESCRIPTION

The miniature linear motor driving device according to the invention utilizes primarily the principle of electromagnetic induction, which, through the magnetic action between the magnetic guide rail and the driving coil, causes the driving coil to move. When current is applied to the driving coil, the coil moves in one direction along the guide rail when the electromagnetic force generated thereof attracts the magnetic force of the magnetic guide rail; conversely, by applying inverse current to the driving coil, the electromagnetic force induced thereof and the magnetic force of the magnetic guide rail would repel each other, and the coil would move in another direction along the guide rail. Based on such phenomenon, the holder, which has driving coil assembled thereon, would be driven by the driving coil to achieve the purpose of moving the lens unit mounted on the holder.

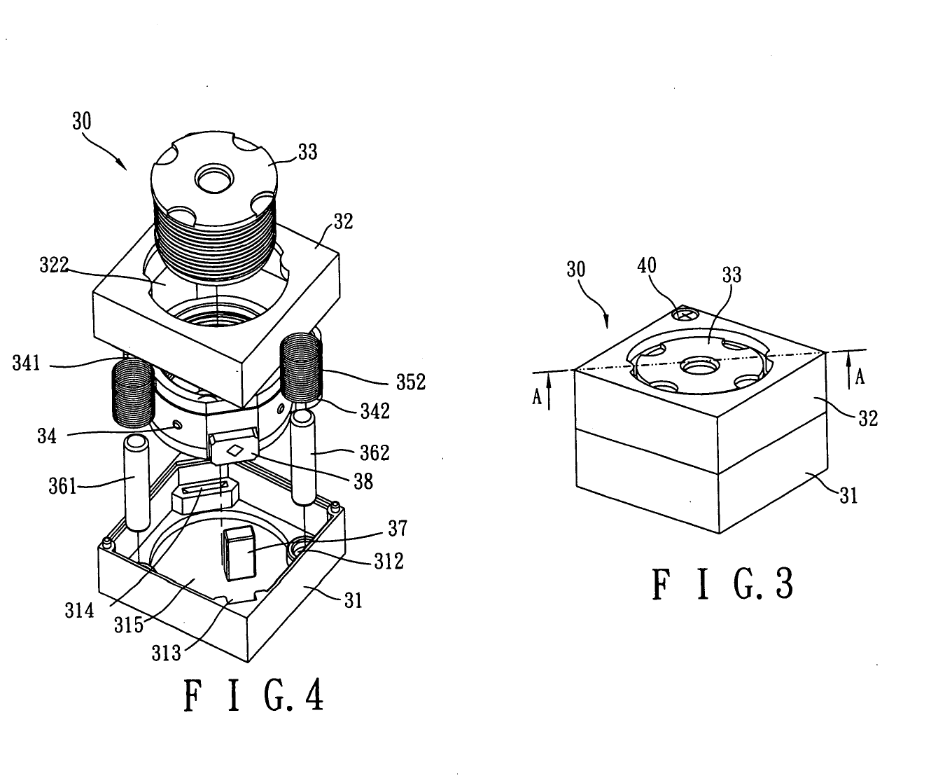

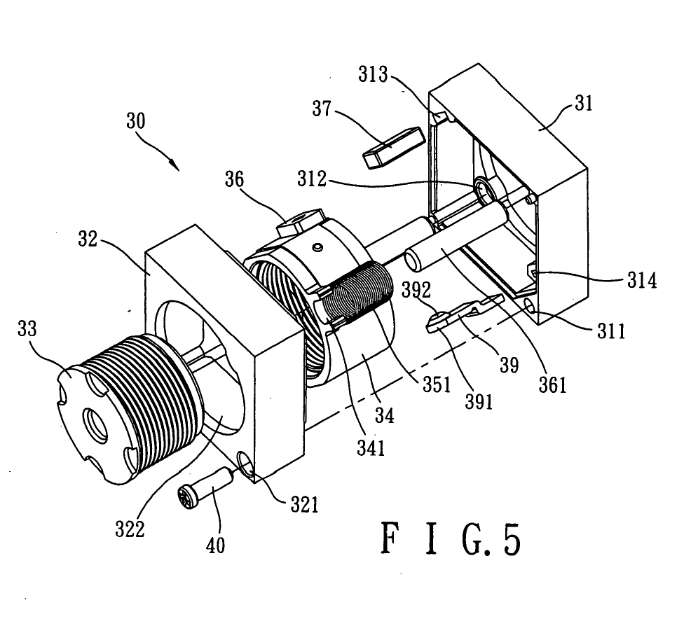

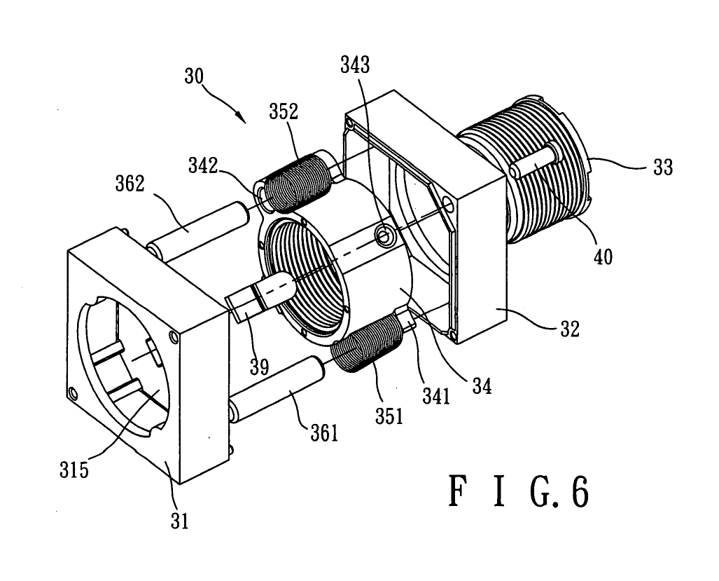

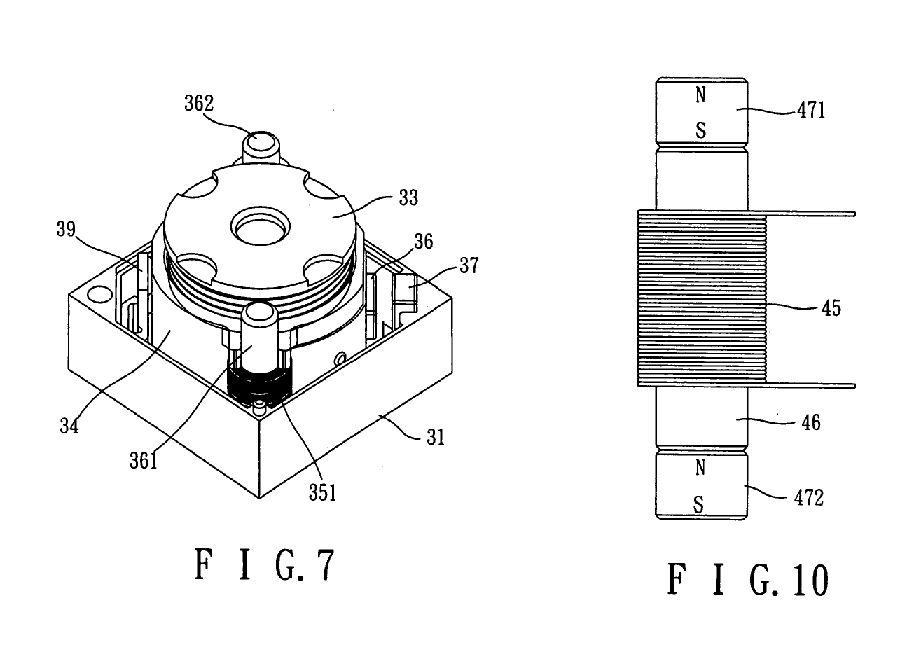

FIGS. 3˜7 disclose a preferred embodiment of the miniature linear motor driving device according to the present invention that is mounted on an auto-focus lens unit to form a auto-focus lens device 30. FIG. 3 is an external view of a preferred embodiment of the auto-focus lens device 30 in assembly with a miniature linear motor driving device. FIG. 4 is an exploded view of the auto-focus lens device shown in FIG. 3 under the first viewing angle. FIG. 5 is an exploded view of the auto-focus lens device shown in FIG. 3 under the second viewing angle. FIG. 6 is an exploded view of the auto-focus lens device shown in FIG. 3 under the third viewing angle. FIG. 7 is an external view of the auto-focus lens device in FIG. 3 in assembly state after the removal of upper cover.

As shown in FIGS. 3˜7, the auto-focus lens device 30 having a miniature linear motor driving device according to the invention comprises a base 31, a cover 32, a lens barrel 33, a holder 34, at least a driving coil (including a first coil 351 and a second coil 352), at least a magnetic guide rail 36 (including a first magnetic guide rail 361 and a second magnetic guide rail 362), a permanent magnet 37, a magnetic sensor 38, a prepressed spring 39, and a bolt 40.

The base 31 and cover 32 fit each other. The cover 32 and base 31 are disposed respectively with a through-hole 321 and a bolt opening 311 thereon. By passing the bolt 40 through the through-hole and locking it into the bolt opening, the base 31 and cover 32 are secured to each other in one body with a space in between to accommodate the aforementioned elements. A plurality of recesses of specific shape 312, 313, and 314 are disposed at the predetermined locations of base 31 for positioning the magnetic guide rails 361, 362, permanent magnet 37, and prepressed spring 39, and holding those elements in place after cover 32 and base 31 adjoin each other. Furthermore, an opening 351 and 322 is disposed respectively at the anterior and posterior locations of lens barrel 33 corresponding to the cover 32 and base 31 for light rays to pass through the lens barrel 33.

The lens barrel 33 is an optical lens set comprising a plurality of lenses and having screw threads at its periphery. Or, in another preferred embodiment, the lens barrel is a zoom lens set. The optical lens set and zoom lens set described are prior art and not one of the features of the invention. Thus their detailed constitution will not be elaborated below.

The holder 34 is for retaining the lens barrel 33. In this preferred embodiment, the holder 34 has a through-hole with internal threads at the center, and the internal diameter of the through-hole corresponds to the outer diameter of the lens barrel 33 so the lens barrel 33 can engage and position in the through-hole on holder 34. A guide hole 341, 342 is disposed respectively on the two opposing sides of holder 34. The first coil 351 and the second coil 352 are respectively wound around the periphery of guide holes 342 and 342 so the guide holes 341 and 342 align with the center holes of coil 351 and 352.

The first magnetic guide rail 361 and second magnetic guide rail 362 are respectively disposed through the guide holes 341, 342, and the first coil 351 and second coil 352. In this preferred embodiment, the first and second magnetic guide rails 361 and 362 are rod-shape permanent magnets. Each magnetic guide rail has a first polarity and a second polarity of opposite pole at the ends. In light that the holder 34 is essentially seated over the first and the second magnetic guide rail 361, 362, it is guided (confined) by the guide rails and engages in limited linear movement (i.e. the distance of displacement is no greater than the length of magnetic guide rails 361, 362) along the extended direction of magnetic guide rails 361, 362.

The permanent magnet 37 is attached to base 31 and faces the accommodation space. The magnetic sensor 38 is mounted on holder 34 and corresponds to the permanent magnet 37. When holder 34 displaces, the magnetic sensor 38 detects change in the magnetic force of permanent magnet 37 and produces a corresponding voltage signal. The value of said voltage signal is a function of the magnetic force detected by magnetic sensor 38. That is, the value of voltage signal corresponds to the position of holder 34. By converting the value of voltage signal output by the magnetic sensor 38, the position of magnetic sensor 38 (also that of lens barrel 33) may be obtained as position feedback during the displacement of lens barrel 33. The present invention employs the small-sized magnetic sensor 30 that takes little space and practically does not require any additional precision elements or expensive optical positioning device in order to detect the position of lens barrel 33, thereby offering the advantages of fewer elements, simple structure, small size, lower cost, and precision positioning.

The prepressed spring 39 has one end attached to the base 31 and the other end 391 free and swingable. The free end 391 of prepressed spring 39 is disposed with a protrusion 392, while the holder 34 has a concavity 343 at the location corresponding to the protrusion 392. When the holder 34 is at its initial position (e.g. when coils 351 and 352 are not charged with current), the protrusion 392 engages exactly the concavity 343 on holder 34 to secure the holder 34. When the holder 34 is driven and displaces, the protrusion 392 on the prepressed spring 39 disengages the concavity 343 on holder 34. At this time, the prepressed spring 39 bends and deforms to furnish a predetermined pressure on the holder 34 to render the lens barrel 33 more stable in the course of displacement and eliminate the gap between guide holes 341, 342 on holder 34 and magnetic guide rails 361, 362.

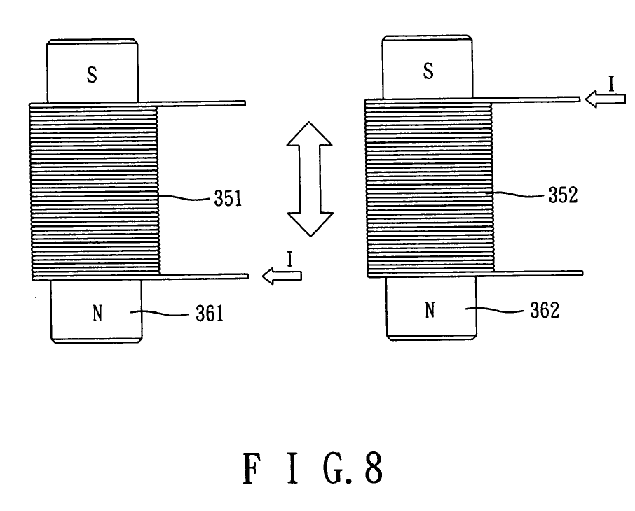

FIG. 8 is a diagram showing the magnetic action between magnetic guide rail and driving coil in the miniature linear motor driving device according to the invention. As shown, when current is applied to coils 351 and 352, the coils 351, 352 generates a predetermined electromagnetic force and interacts with the S and N poles at the upper and lower ends of magnetic guide rails. If the induced electromagnetic force attracts the magnetic force of magnetic guide rails 361, 362, the coils 351, 352 would move in one direction along magnetic guide rails 361, 362. Conversely, when inverse current is applied to coils 351, 352, the electromagnetic force induced thereof and the magnetic force of magnetic guide rails 361, 362 would repel each other, and the coils 351, 352 would move in another direction along the magnetic guide rails 361, 362. Based on such phenomenon, the holder that has coils 351, 352 assembled thereon would, together with the lens barrel 33 mounted thereon, engage in linear displacement along the extended direction of magnetic guide rails 361, 362 as driven by the coils 351, 352, and the distance it displaces is confined by the length of magnetic guide rails 361, 362. As such, the magnetic guide rails 361, 362 provide the dual functions of “electromagnetic actuation” and “displacement guidance.” Thus the present invention does not need to install extra displacement guide and further cuts down the number of elements, reduces the size and simplify the structure of device. In addition, as the magnetic flux lines of driving coils converge directly on the magnetic guide rail, better driving efficiency is achieved and more power is saved.

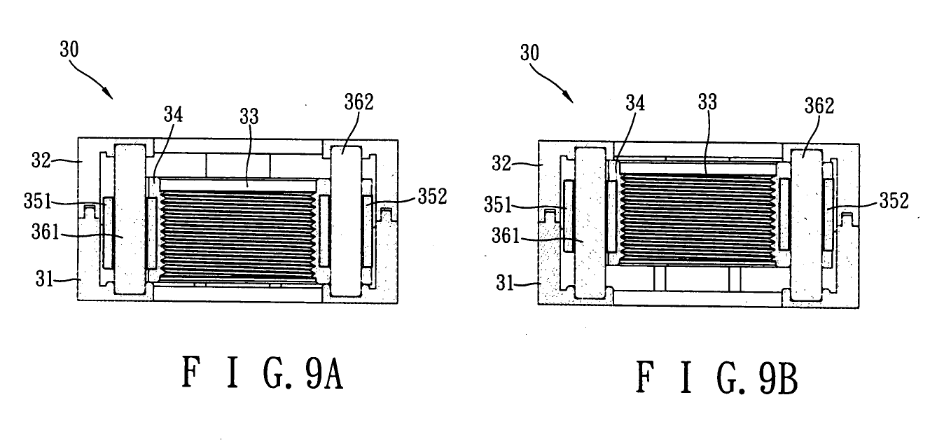

FIG. 9A and FIG. 9B are A-A sectional views of the auto-focus lens device in FIG. 3 showing respectively the holder 34 being driven and shifted to a posterior position (FIG. 9A) and an anterior position (FIG. 9B).

FIG. 10 is another preferred embodiment of magnetic guide rail in the miniature linear motor driving device according to the invention. As shown, the magnetic guide rail is a rod-shape magnetically permeable element 46 (e.g. made of yoke) having a permanent magnet 471, 472 arranged at each end. The two permanent magnets 471 and 472 induce the ends of rod-shape magnetically permeable element 46 to form respectively a first polarity and a second polarity of opposite poles, which similarly could interact with coil 45 to produce driving force. The length of magnetically permeable element 46 is less restricted, and its cost is lower.

It should be noted that the above described embodiments are not to be construed as limiting the applicable scope of the invention, but instead the protective scope of the invention should be defined by the technical spirit of the appended claims along with their full scope of equivalents. In other words, equivalents and modifications made based on the appended claims still accords with the intention of the invention and dose not depart from the spirit and scope of the invention. Thus, all should be regarded as further implementions of the invention.

What is claimed is:

1. A miniature linear motor driving device, comprising:
a holder disposed with at least a guide hole;
at least a driving coil wound around the periphery of the guide hole; and
at least a magnetic guide rail disposed through the guide hole and formed with a first polarity and a second polarity at its ends that allows the holder to engage in linear displacement along its directions;
wherein by passing current through said driving coil, a predetermined magnetic force is generated to interact with the polarities at the ends of magnetic guide rail, which pushes the holder to engage in linear displacement along the magnetic guide rail.

2. The miniature linear motor driving device according to claim 1, wherein said magnetic guide rail is a rod-shape permanent magnet.

3. The miniature linear motor driving device according to claim 1, wherein said magnetic guide rail is a magnetically permeable element having a permanent magnet arranged at both ends, which induces the ends to form respectively a first polarity and a second polarity of opposite poles.

4. The miniature linear motor driving device according to claim 3, wherein said magnetically permeable element is made of yoke.

5. The miniature linear motor driving device according to claim 1, further comprising a lens barrel held in said holder.

6. The miniature linear motor driving device according to claim 5, further comprising a base and a cover that fit each other and have a space therebetween to accommodate the lens barrel, the holder, the driving coil and magnetic guide rail; an opening is configured respectively at the anterior and posterior locations of lens barrel corresponding to the base and the cover to allow passage of light rays.

7. The miniature linear motor driving device according to claim 6, further comprising:
a permanent magnet mounted on either the base or the cover and facing the accommodation space;
a magnetic sensor attached to the holder and arranged opposite to said permanent magnet; when the holder displaces, the magnetic sensor can detect change in the magnetic force of said permanent magnet and produce a corresponding voltage signal where the value of said voltage signal corresponds to the position of said holder.

8. The miniature linear motor driving device according to claim 6, further comprising:
a prepressed spring having one end secured to the base or the cover and the other end free and swingable; the free end of prepressed spring is configured with a protrusion; and
a concavity configured on the holder and corresponding to said protrusion; when the holder is at its initial position, the protrusion engages exactly the concavity on holder to secure the holder; when the holder is driven and displaces, the protrusion on the prepressed spring disengages the concavity on holder, and at the same time, the prepressed spring bends and deforms to furnish a predetermined pressure on the holder to render the lens unit more stable in the course of displacement and eliminate the gap between guide holes on holder and magnetic guide rails.

9. A auto-focus lens device with a miniature linear motor driving device, comprising:
a magnetic guide rail extending a predetermined length and having a first polarity and a second polarity at each ends respectively;
a driving coil wound around the exterior of said magnetic guide rail with a predetermined distance apart in between; when a current is applied to said driving coil, the coil produces a predetermined magnetic force to interact with the polarities at both ends of the magnetic guide rail, thereby causing the displacement motion between them, and said displacement motion is essentially confined by the extended direction and length of magnetic guide rail; and
a lens barrel linked to either the magnetic guide rail or the driving coil that when the magnetic guide rails or driving coil moves towards each other, the lens barrel is driven along.

10. The auto-focus lens device according to claim 9, wherein said magnetic guide rail is a rod-shape permanent magnet.

11. The auto-focus lens device according to claim 9, wherein said magnetic guide rail is a magnetically permeable element having a permanent magnet arranged at both ends, which induces the ends to form respectively a first polarity and a second polarity of opposite poles.

12. The auto-focus lens device according to claim 11, wherein said magnetically permeable element is made of yoke.

13. The auto-focus lens device according to claim 9, wherein said lens barrel is linked to said driving coil.

14. The auto-focus lens device according to claim 9, further comprising a holder having said lens barrel mounted thereon and configured with at least a guide hole thereon; said driving coil is wound around said guide hole and linked with the holder, and said magnetic guide rail is disposed through the guide hole to allow the holder to engage in linear displacement along the magnetic guide rail.

15. The auto-focus lens device according to claim 9, further comprising a base and a cover that fit each other and have a space therebetween to accommodate the lens barrel, the holder, the driving coil and magnetic guide rail; an opening is configured respectively at the anterior and posterior locations of lens barrel corresponding to the base and the cover to allow passage of light rays.

16. The auto-focus lens device according to claim 15, further comprising:
a permanent magnet mounted on either the base or the cover and facing the accommodation space;
a magnetic sensor attached to the holder and arranged opposite to said permanent magnet; when the holder displaces, the magnetic sensor can detect change in the magnetic force of said permanent magnet and produce a corresponding voltage signal where the value of said voltage signal corresponds to the position of said holder.

17. The auto-focus lens device according to claim 15, further comprising:
a prepressed spring having one end secured to the base or the cover and the other end free and swingable; the free end of prepressed spring is configured with a protrusion; and
a concavity configured on the holder and corresponding to said protrusion; when the holder is at its initial position, the protrusion engages exactly the concavity on holder to secure the holder; when the holder is driven and displaces, the protrusion on the prepressed spring disengages the concavity on holder, and at the same time, the prepressed spring bends and deforms to furnish a predetermined pressure on the holder to render the lens unit more stable in the course of displacement and eliminate the gap between guide holes on holder and magnetic guide rails.
